(19) United States
(12) Patent Application Publication
(10) Pub. No.: US 2006/0179937 A1
(43) Pub. Date: Aug. 17, 2006

(54) Fill level sensor, measuring method for determining a contact pressure of a contact against a contact path of a potentiometer and device for carrying out the measuring method

(76) Inventors: Hans-Guenter Benner, Kriftel (DE); Sebastian Hagen, Arnsberg (DE); Bernd Pauer, Eppstein (DE); Robert Peter, Sulzbach (DE)

Correspondence Address: MAYER, BROWN, ROWE & MAW LLP, P.O. BOX 2828, CHICAGO, IL, 60690-2828, US

(21) Appl. No.: 10/547,912

(22) PCT Filed: Jul. 7, 2004
(86) PCT No.: PCT/EP04/51373

§ 371 Date: Dec. 14, 2005

(30) Foreign Application Priority Data
Aug. 8, 2003 (DE) 10336791.8

(51) Int. Cl. G01F 23/36; G01F 25/00

(52) U.S. Cl. 73/313; 73/314; 73/317; 73/1.73

(57) ABSTRACT

A filling level sensor (1) for a fuel container having a bracket (4) which can pivot by means of a carrier (5) has an opening (9) in the carrier (5). A measuring tip (13) can be lead through the opening (9) toward a component which is connected to contacts (10) of a potentiometer (7) and a lifting-off force of the contact (10) can be determined. The lifting-off force is thus measured in a low-friction fashion and near to the contacts (10).

### BACKGROUND OF THE INVENTION

The invention relates to a filling level sensor for generating electrical signals as a function of a pivot angle of a lever arm, fitted with a float, for a container, in particular a fuel container or a washing fluid container of a motor vehicle having a carrier which is provided for fastening to a lateral wall in the container, having a bracket which is fabricated from plastic and can pivot in a bearing of the carrier, having a lever wire which secures the float and is fastened to the bracket, having a potentiometer which sensors the pivot angle of the lever arm, and having a slider track which is arranged on the carrier and the contact of the potentiometer which is fastened to the bracket. Furthermore, the invention relates to a measuring method for determining a lifting-force of a contact—which moves via a slider track—of a potentiometer of a filling level sensor, the contact being removed from the slider track up to a point where contact is interrupted, and the force which is necessary for interrupting contact is measured, and a device for carrying out the measuring method.

Such filling level sensors are frequently used to determine a filling level in the fuel container and are known from practice. For the filling level sensor to function reliably it is necessary to ensure that the contact bears reliably against the slider track. The force which is necessary to lift off the contact from the slider track is measured on a trial basis with various filling level sensors. In order to carry out a measurement, a tie rod hook engages around the bracket and the tie rod hook is connected to a spring balance. The spring balance is then lifted off until the electrical contact between the contact and the flat track is interrupted. The measured value of the spring balance is read off at this moment.

A disadvantage with the known filling level sensors and the known measuring method is that the measured values fluctuate very widely and can therefore only be reproduced to a limited degree. The fluctuation is due to the friction between the tie rod hook and the bracket which is inevitably subject to tolerances and fabrication inaccuracies.

The invention is based on the problem of developing a filling level sensor of the type specified at the beginning in such a way that it permits simple measurement of the force which is necessary to lift the contact from the slide track. Furthermore, a measuring method is to be provided which has a particularly high degree of accuracy when determining the lifting-off force, and a device for carrying out the method which is of particularly simple design is to be provided.

The aforesaid problem is solved according to the invention in that the carrier has, in the region of the slider track, an opening for leading through a measuring tip which can be moved toward a component which is connected to the contact, and in that a component which is connected to the contact is arranged in the region of the opening.

As a result of this configuration, a force can be applied to the bracket through the opening of the carrier. Thanks to the invention, a pressing force can be applied to the bracket. When the measuring tip is fed through the opening, it can press directly against the component which is connected to the contact. As a result, the filling of the sensor according to the invention permits the lifting-off force at the contact to be determined directly. The component which is connected to the contact is probably a flat, contact spring which is usually present in any case to prestress the contacts.

When the slider tracks are particularly wide, the lifting-off force can easily be determined according to one advantageous development of the invention if the opening penetrates the slider track.

Potentiometers frequently have two contacts which are connected to one another and which span two slider tracks. According to another advantageous development of the invention, such potentiometers require particularly little structural complexity to determine the lifting-off force if the opening is arranged in the center between two slider tracks.

The problem mentioned second, namely to provide a measuring method which has a particularly high level of accuracy when determining the lifting-off force, is solved according to the invention in that the measuring tip is pressed from the side of the slider track perpendicularly onto a component which holds the contact, and in that the pressing force of the measuring tip is determined.

As a result of this configuration, a pressing force is applied to the component, in particular a contact spring, which holds the contact, and the lifting-off force is determined from this pressing force. Since the pressing force can be applied to the contact with significantly less friction and the pulling force by means of a tie rod, the fluctuation when determining the pulling-off force is kept particularly low. The measuring method according to the invention therefore has a particularly high level of accuracy.

In a further configuration, the contacts are arranged on a contact plate which is prestressed against the contact by an additional prestressing spring. In this arrangement, the measuring tip is pressed against the contact plate, the prestressing spring generating the prestressing force via the contact plate.

According to one advantageous development of the invention, the measuring tip can be moved particularly close to the contact if the measuring tip is pressed through an opening in the slider track or between two contact tracks.

A device for carrying out the method which is of particularly simple design and which determines the lifting-off force of a particularly high level of accuracy is provided according to the invention by a securing element for securing a carrier of the filling level sensor, a drive device for moving the measuring tip through an opening in the carrier toward the component which is connected to the contact and by a force-sensing device for determining the force between the carrier and the measuring tip.

By means of this configuration, the filling level sensors can be connected to the securing element and the measuring tip can then move, by means of the drive device, toward the component which is connected to the contact. The force which is necessary when lifting off the contact from the slider tracks is then determined by the force-sensing device. The device for carrying out the measuring method therefore requires particularly few components.

### BRIEF DESCRIPTION OF THE DRAWINGS

The invention permits numerous embodiments. In order to clarify the basic principle further, one of said embodiments is illustrated in the drawing and will be described below. In said drawing:

FIG. 1 shows a plan view of a filling level sensor according to the invention, and

FIG. 2 shows a sectional view through the filling level sensor with a schematically illustrated device for carrying out a measuring method.

### DETAILED DESCRIPTION OF THE INVENTION

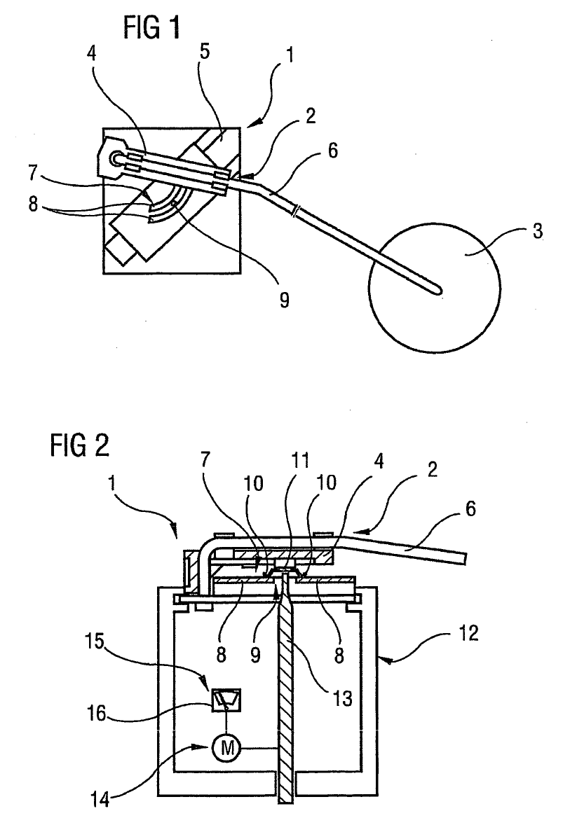

FIG. 1 shows a filling level sensor 1 according to the invention, having a float 3 which is fastened to a lever arm 2. The lever arm 2 is pivotably mounted, by means of a bracket for which it is fabricated from plastic, on a carrier 5 and has a lever wire 6, fastened to the bracket 4, for securing the float 3. In the state in which the filling of sensor 1 is mounted in a container (not illustrated), the float 3 follows a fluid level and in doing so pivots the lever arm 2. The pivoting angle of the lever arm 2 is sensed by a potentiometer 7. The potentiometer 7 has two slider tracks 8 which are arranged on the carrier 5. The carrier 5 has an opening 9 between the slider tracks 8.

As is shown by FIG. 2 in a sectional view through the filling level sensor 1 for FIG. 1, the potentiometer 7 has two contacts 10 which are fastened to the bracket 4. The contacts 10 are fabricated in one piece with a contact spring 11 which is fastened to the bracket 4. The contacts 10 are prestressed against the slider track by means of the contact spring 11. In FIG. 2, for the sake of clarification the bracket 4 is illustrated pivoted with the opening 9.

Furthermore, FIG. 2 shows a device for carrying out a measuring method which determines a lifting-off force of the contacts 10 of the potentiometer 7 on the slider tracks 8. The device has a securing element 12 for securing the carrier 5 of the filling level sensor 1 and a measuring tip 13 which is lead through the opening 9 in the carrier 5 to the contact spring 11. The measuring tip 13 is guided in a longitudinally movable fashion in the direction of the contact spring 11 and can move toward the contact spring 11 by means of a drive device 14. A force-sensing device 15 with a display 16, which is illustrated schematically, measures the force with which the measuring tip 13 is pressed against the contact spring 11.

In order to measure the lifting-off force of the contacts 10 of the potentiometer 7 from the slider tracks 8, the filling level sensor 1 is fastened, with the carrier 5, in the securing element 12. The lever arm 2 with the contact spring 11 is then moved via the opening 9 in the carrier 5, and the measuring tip 13 is moved, driven by the drive device 14, against the contact spring 11 and pressed away from the slider tracks 8 as the force increases. In the process, the signals of the potentiometer 7 are sensed. If at least one of the contacts 10 lifts off from the slide tracks 8, the signal of the potentiometer 7 changes and the force on the drive device 14 is sensed by the force-detecting device 15 at this time, and can be read off by the display 16.

1. A filling level sensor for generating electrical signals as a function of a pivot angle of a lever arm fitted with a float responsive to the level of fluid within a container on a motor vehicle, the sensor having (a) a carrier which is provided for fastening to a lateral wall in the container, (b) a bracket which is fabricated from plastic and can pivot in a bearing of the carrier, (c) a lever wire which secures the float and is fastened to the bracket, (d) a potentiometer which sensors the pivot angle of the lever arm, with a slider track which is arranged on the carrier and a contact which is fastened to the bracket, characterized in that the carrier (5) has, in the region of the slider track (8), an opening (9) for leading through a measuring tip (13), which can move against a component which is connected to a contact (10), and in that a component which is connected to the contact (10) is arranged in the vicinity of the opening (9).

2. The filling level sensor as claimed in claim 1, characterized in that the opening (9) penetrates the slider track (8).

3. The filling level sensor as claimed in claim 1 or 2, characterized in that the opening (9) is arranged in the center between two slider tracks (8).

4. A measuring method for determining a lifting-off force of a contact—which moves via a slider track—of a potentiometer of a filling level sensor, the contact being removed from the slider track up to a point where contact is interrupted, and the force which is necessary for interrupting contact is measured, characterized in that the measuring tip is pressed from the side of the slider track perpendicularly onto a component which holds the contact, and in that the pressing force of the measuring tip is determined.

5. Measuring method as claimed in claim 4, characterized in that the measuring tip is pushed through an opening in the slider track or between two contact tracks.

6. A device as defined in claim 1, characterized by a securing element (12) for securing the carrier (5) of the filling level sensor, a drive device (14) for moving a measuring tip (13) through the opening (9) in the carrier (5) toward the component which is connected to the contact (10) and by a force-sensing device (15) for determining the force between the carrier (5) and the measuring tip (13).
